(19) United States
(12) Patent Application Publication
(10) Pub. No.: US 2023/0038477 A1
(43) Pub. Date: Feb. 9, 2023

(54) RESIN COMPOSITION FOR REFRIGERANT TRANSPORTING HOSES, AND REFRIGERANT TRANSPORTING HOSE

(71) Applicant: The Yokohama Rubber Co., LTD., Tokyo (JP)

(72) Inventor: Shun SATO, Kanagawa (JP)

(21) Appl. No.: 17/759,075

(22) PCT Filed: Dec. 17, 2020
(86) PCT No.: PCT/JP2020/047266

§ 371 Date: Jul. 19, 2022

(30) Foreign Application Priority Data
Jan. 24, 2020 (JP) 2020-009902

(51) Int. Cl. C08L 9/00; F16L 11/08

(52) U.S. Cl. CPC C08L 9/00; F16L 11/085; C08L 2201/14; C08L 2205/02

(57) ABSTRACT

A resin composition for a refrigerant-transporting hose contains a thermoplastic resin and an elastomer, the thermoplastic resin and the elastomer forming a sea-island structure of a matrix of the thermoplastic resin and a domain of the elastomer, the resin composition having a P(O₂), an M10, and a P(H₂O) satisfying2: 0 < P(O₂) x M10 ≤ 150 and log(P(H₂O)/P(O₂)) ≤ 0.9, where the P(O₂) is an oxygen permeability coefficient [cm·cm³/(cm²·s·cmHg)] at a temperature of 21° C. and a relative humidity of 50%, the M10 is a 10% modulus [MPa] at a temperature of 25° C., and the P(H₂O) is a water vapor permeability coefficient [cm·cm³/(cm²·s·cmHg)] at a temperature of 60° C. and a relative humidity of 100%.

### TECHNICAL FIELD

The present technology relates to a resin composition for a refrigerant-transporting hose, and a refrigerant-transporting hose.

### BACKGROUND ART

With the increasing demand for weight reduction of automobiles, efforts have been made to achieve the weight reduction by manufacturing hoses, which have been made of rubber and used in automobiles, with a resin having high barrier properties in place of rubber to reduce thickness. In particular, the main material of the refrigerant-transporting hose of the current automobile air conditioners is rubber, and if the main material can be substituted with a resin having high barrier properties, the weight reduction can be achieved.

For example, Japan Patent No. 3208920 Bdescribes a refrigerant-transporting hose in which an innermost layer is formed of a resin layer having a sea-island structure, the sea-island structure having a sea phase containing mostly a nylon resin and a land phase containing a copolymer of isobutylene and p-methylstyrene in which one or some hydrogen atoms in the molecule are halogenated.

Examples of the resin having high barrier properties include ethylene-vinyl alcohol copolymers and polyamide. An ethylene-vinyl alcohol copolymer alone or polyamide alone does not readily allow oxygen to permeate therethrough but readily allow water vapor to permeate therethrough.

### SUMMARY

The present technology provides a resin composition that can achieve low gas permeability, flexibility, and low water vapor permeability required for a refrigerant-transporting hose in a balanced manner.

A first embodiment of the present technology is a resin composition for a refrigerant-transporting hose, the resin composition containing:
a thermoplastic resin; and
an elastomer;
the thermoplastic resin and the elastomer forming a sea-island structure of a matrix of the thermoplastic resin and a domain of the elastomer,
the resin composition having a P(O₂), an M10, and a P(H₂O) satisfying Formulas 1 and 2:
   0 < P(O₂) x M10 ≤ 150 (Formula 1), and
   log(P(H₂O)/P(O₂)) ≤ 0.9 (Formula 2),
   where the P(O₂) is an oxygen permeability coefficient [cm·cm³/(cm²·s·cmHg)] at a temperature of 21° C. and a relative humidity of 50%, the M10 is a 10% modulus [MPa] at a temperature of 25° C., and the P(H₂O) is a water vapor permeability coefficient [cm·cm³/(cm²·s·cmHg)] at a temperature of 60° C. and a relative humidity of 100%.

A second embodiment of the present technology is a refrigerant-transporting hose including a layer of the resin composition of the first embodiment of the present technology.

The present technology includes the following embodiments.
[1] A resin composition for a refrigerant-transporting hose, the resin composition containing:
   a thermoplastic resin; and
   an elastomer;
   the thermoplastic resin and the elastomer forming a sea-island structure of a matrix of the thermoplastic resin and a domain of the elastomer,
   the resin composition having a P(O₂), an M10, and a P(H₂O) satisfying Formulas and 2:
      0 < P(O₂) x M10 ≤ 150 (Formula 1), and
      log(P(H₂O)/P(O₂)) ≤ 0.9 (Formula 2),
      where the P(O₂) is an oxygen permeability coefficient [cm·cm³/(cm²·s·cmHg)] at a temperature of 21° C. and a relative humidity of 50%, the M10 is a 10% modulus [MPa] at a temperature of 25° C., and the P(H₂O) is a water vapor permeability coefficient [cm·cm³/(cm²·s·cmHg)] at a temperature of 60° C. and a relative humidity of 100%.
[2] The resin composition for a refrigerant-transporting hose according to [1], wherein the water vapor permeability coefficient P(H₂O) at a temperature of 60° C. and a relative humidity of 100% is 60 × 10⁻¹² cm·cm³/(cm²·s·cmHg) or less.
[3] The resin composition for a refrigerant-transporting hose according to [1] or [2], wherein the oxygen permeability coefficient P(O₂) at a temperature of 21° C. and a relative humidity of 50% is 20 × 10⁻¹² cm·cm³/(cm²·s·cmHg) or less.
[4] The resin composition for a refrigerant-transporting hose according to any of [1] to [3], wherein the 10% modulus M10 at a temperature of 25° C. is 10 MPa or less.
[5] The resin composition for a refrigerant-transporting hose according to any of [1] to [4], wherein an oxygen permeability coefficientP_{R}(O₂) [cm·cm³/(cm²·s·cmHg)] of the thermoplastic resin at a temperature of 21° C. and a relative humidity of 50% and a water vapor permeability coefficient P_{R}(H₂O) [cm·cm³/(cm²·s·cmHg)] of the thermoplastic resin at a temperature of 60° C. and a relative humidity of 100% satisfy Formula 3:
   log(P_{R}(H₂O)/P_{R}(O₂))≤ 5.0 (Formula 3).
[6] The resin composition for a refrigerant-transporting hose according to any of [1] to [5], wherein the thermoplastic resin is at least one selected from the group consisting of a polyamide resin, a polyester resin, a vinyl alcohol resin, and a polyketone resin.
[7] The resin composition for a refrigerant-transporting hose according to any of [1] to [6], wherein an oxygen permeability coefficientP_{E}(O₂) [cm·cm³/(cm²·s·cmHg)] of the elastomer at a temperature of 21° C. and a relative humidity of 50% and a water vapor permeability coefficientP_{E}(H₂O) [cm·cm³/(cm²·s·cmHg)] of the elastomer at a temperature of 60° C. and a relative humidity of 100% satisfy Formula 4:
   log(P_{E}(H₂O)/P_{E}(O₂)) ≤ 1.5 (Formula 4).
[8] The resin composition for a refrigerant-transporting hose according to any of [1] to [7], wherein the elastomer is at least one selected from the group consisting of a butyl rubber, a modified butyl rubber, an olefin thermoplastic elastomer, a styrene thermoplastic elastomer, a polyamide elastomer, and a polyester elastomer.
[9] The resin composition for a refrigerant-transporting hose according to any of [1] to [8], further containing at least one processing aid selected from the group consisting of a fatty acid, a fatty acid metal salt, a fatty acid ester, and a fatty acid amide.
[10] A refrigerant-transporting hose including a layer of the resin composition accordingto any of [1] to [9].

The resin composition according to an embodiment of the present technology has low gas permeability and flexibility required for the refrigerant-transporting hose, and also has excellent low water vapor permeability.

### DETAILED DESCRIPTION

A first embodiment of the present technology is a resin composition for a refrigerant-transporting hose, the resin composition containing:
a thermoplastic resin; and
an elastomer;
the thermoplastic resin and the elastomer forming a sea-island structure of a matrix of the thermoplastic resin and a domain of the elastomer,
the resin composition having a P(O₂), an M10, and a P(H₂O) satisfying Formulas 1 and 2:
   0 < P(O₂) x M10 ≤ 150 (Formula 1), and
   log(P(H₂O)/P(O₂)) ≤ 0.9 (Formula 2),
   where the P(O₂) is an oxygen permeability coefficient [cm·cm³/(cm²·s·cmHg)] at a temperature of 21° C. and a relative humidity of 50%, the M10 is a 10% modulus [MPa] at a temperature of 25° C., and the P(H₂O) is a water vapor permeability coefficient [cm·cm³/(cm²·s·cmHg)] at a temperature of 60° C. and a relative humidity of 100%.

The first embodiment of the present technology relates to the resin composition for a refrigerant-transporting hose, the resin composition containing a thermoplastic resin and an elastomer. The refrigerant-transporting hose refers to a hose for transporting a refrigerant for an air conditioner or the like. The resin composition according to an embodiment of the present technology can be particularly suitably used to manufacture a hose for transporting a refrigerant for an air conditioner of an automobile. A refrigerant-transporting hose is usually composed of an inner tube, a reinforcing layer, and an outer tube, and the thermoplastic resin composition according to an embodiment of the present technology can be particularly suitably used to manufacture particularly the inner tube of the refrigerant-transporting hose. Examples of the refrigerant for an air conditioner include hydrofluorocarbons (HFCs), hydrofluoroolefins (HFOs), hydrocarbons, carbon dioxide, and ammonia. Examples of the HFC include R410A, R32, R404A, R407C, R507A, and R134a. Examples of the HFO include R1234yf, R1234ze, R1233zd, R1123, R1224yd, and R1336mzz. Examples of the hydrocarbon include methane, ethane, propane, propylene, butane, isobutane, hexafluoropropane, and pentane. In embodiments of the present technology, low gas permeability refers to a property of being less likely to allow gas such as the refrigerant described above to permeate therethrough.

In a refrigerant-transporting hose used in an air conditioner of an automobile or the like, permeation of water and/or water vapor from the outer side of the hose causes freezing of moisture inside the air conditioner. Thus, a material with excellent low permeability of water and/or water vapor is required, and a butyl rubber, an ethylene/propylene copolymer rubber, or the like has been used in the related art.

The resin composition according to an embodiment of the present technology contains a thermoplastic resin and an elastomer, and the thermoplastic resin and the elastomer form a sea-island structure of a matrix of the thermoplastic resin and a domain of the elastomer. In other words, the resin composition according to an embodiment of the present technology is composed of a matrix and a domain dispersed in the matrix. The ratios of the matrix and the domain are not limited as long as the effects of the present technology are achieved, but preferably, the volume ratio of the matrix in the resin composition is from 25 to 50 vol.% and the volume ratio of the domain in the resin composition is from 50 to 75 vol.%. The volume ratio of the matrix in the resin composition is more preferably from 25 to 40 vol.% and even more preferably from 30 to 40 vol.%. In a case where the volume ratio of the matrix is too low, a phase inversion of the matrix and the domain would occur, and the sea-island structure may be reversed. In a case where the volume ratio of the matrix is too high, the content of the thermoplastic resin constituting the matrix would increase, and thus the desired flexibility may not be obtained.

For the resin composition according to an embodiment of the present technology, an oxygen permeability coefficient P(O₂) [cm·cm³/(cm²·s·cmHg)] at a temperature of 21° C. and a relative humidity of 50% and a 10% modulus M10 [MPa] at a temperature of 25° C. satisfy the following formula:
0 < P(O₂) x M10 ≤ 150 (Formula 1), preferably satisfy:
5 ≤ P(O₂) x M10 ≤ 130 (Formula 1'), and more preferably satisfy:
10 ≤ P(O₂) x M10 ≤ 110 (Formula 1").

The resin composition with a P(O₂) and an M10 satisfying Formula 1 provides a hose having low gas permeability as well as being flexible and having excellent handleability.

For the resin composition according to an embodiment of the present technology, an oxygen permeability coefficient P(O₂) [cm·cm³/(cm²·s·cmHg)] at a temperature of 21° C. and a relative humidity of 50% and a water vapor permeability coefficient P(H₂O) [cm·cm³/(cm²·s·cmHg)] at a temperature of 60° C. and a relative humidity of 100% satisfy the following formula:
log(P(H₂O)/P(O₂)) ≤ 0.9 (Formula 2), preferably satisfy:
0.1 ≤ log(P(H₂O)/P(O₂)) ≤ 0.8 (Formula 2'), and more preferably satisfy:
0.2 ≤ log(P(H₂O)/P(O₂)) ≤ 0.7 (Formula 2").

The resin composition with a P(H₂O) and a P(O₂) satisfying Formula 2 provides a hose having low gas permeability as well as reduced mixing of moisture into the inside due to water vapor permeation.

For the resin composition according to an embodiment of the present technology, an oxygen permeability coefficient P(O₂) at a temperature of 21° C. and a relative humidity of 50% is preferably 20 × 10⁻¹² cm·cm³/(cm²·s·cmHg) or less, more preferably 18 × 10⁻¹² cm·cm³/(cm²·s·cmHg) or less, and even more preferably 15 × 10⁻¹² cm·cm³/(cm²·s·cmHg) or less. The lower limit of the P(O₂) is not limited, but the P(O₂) is typically 0.001 × 10⁻¹² cm·cm³/(cm²·s·cmHg) or more. The P(O₂) is within the above range, and this provides a hose that is less likely to permeate the refrigerant gas.

The oxygen permeability coefficient is a measure of low gas permeability; lower oxygen permeability coefficients indicate superior low gas permeability, and higher oxygen permeability coefficients indicate poorer low gas permeability.

The method for measuring the oxygen permeability is not particularly limited, but the oxygen permeability coefficient can be measured using, for example, an OXTRAN 1/50, available from MOCON, Inc.

For the resin composition according to an embodiment of the present technology, a water vapor permeability coefficient P(H₂O) at a temperature of 60° C. and a relative humidity of 100% is preferably 60 × 10⁻¹² cm·cm³/(cm²·s·cmHg) or less, more preferably 50 × 10⁻¹² cm·cm³/(cm²·s·cmHg) or less, and even more preferably 40 × 10⁻¹² cm·cm³/(cm²·s·cmHg) or less. The lower limit of the P(H₂O) is not limited, but the P(H₂O) is typically 0.1 × 10⁻¹² cm·cm³/(cm²·s·cmHg) or more. The P(H₂O) is within the above range, and this can reduce mixing of moisture into the inside of the hose due to water vapor permeation.

The method for measuring the water vapor permeability coefficient is not particularly limited, but the water vapor permeability coefficient can be measured using, for example, a water vapor permeation tester available from GTR Tech Corporation.

For the resin composition according to an embodiment of the present technology, a 10% modulus M10 at a temperature of25° C. is preferably 10 MPa or less, more preferably 9 MPa or less, and even more preferably 8 MPa or less. The lower limit of the M10 is not limited, but the M10 is typically 0.1 MPa or more. The M10 is within the above range, and this produces a hose that is flexible and has excellent handleability.

The 10% modulus can be measured in accordance with JIS (Japanese Industrial Standard) K6301 “Physical Testing Method for Vulcanized Rubber”.

For the thermoplastic resin constituting the matrix, preferably an oxygen permeability coefficient P_{R}(O₂) [cm·cm³/(cm²·s·cmHg)] at a temperature of 21° C. and a relative humidity of 50% and a water vapor permeability coefficient P_{R}(H₂O) [cm·cm³/(cm²·s·cmHg)] at a temperature of 60° C. and a relative humidity of 100% preferably satisfy:
log(P_{R}(H₂O)/P_{R}(O₂))≤ 5.0 (Formula 3), more preferably satisfy:
0.1 ≤ log(P_{R}(H₂O)/P_{R}(O₂)) ≤ 4.5 (Formula 3'), and even more preferably satisfy:
0.2 ≤ log(P_{R}(H₂O)/P_{R}(O₂))≤ 4.0 (Formula 3").

The thermoplastic resin with a P_{R}(O₂) and a water vapor permeability coefficient P_{R}(H₂O)satisfying Formula 3 readily imparts both low gas permeability and low water vapor permeability to the resin composition prepared by compositing the thermoplastic resin with the elastomer.

The thermoplastic resin is not limited as long as the resin composition satisfies Formulas 1 and 2 and the thermoplastic resin satisfies Formula 3 but is preferably at least one selected from the group consisting of a polyamide resin, a polyester resin, a vinyl alcohol resin, and a polyketone resin.

Examples of the polyamide resin include nylon 6, nylon 6/12 copolymers, nylon 11, nylon 12, nylon 66, nylon 610, nylon 6/66 copolymers, nylon 46, nylon 6T, nylon 9T, nylon and MXD6, but the polyamide resin is preferably nylon 6, a nylon 6/12 copolymer, or nylon 12.

Examples of the polyester resin include poly(ethyleneterephthalate), poly(butylene terephthalate), poly(ethylene naphthalate), and poly(butylene naphthalate), but the polyester resin is preferably poly(butylene terephthalate).

Examples of the vinyl alcohol resin includes poly(vinyl alcohol) (PVA), ethylene-vinyl alcohol copolymers (EVOHs), ethylene-vinyl acetate-vinyl alcohol copolymers, and ethylene-butene diol copolymers. Among them, an ethylene-vinyl alcohol copolymer is preferred. The melting point and oxygen permeability coefficient of the ethylene-vinyl alcohol copolymer vary depending on the copolymerization ratio of ethylene and vinyl alcohol. A preferred copolymerization ratio of ethylene is from 25 to 48 mol%. Among these, an ethylene-vinyl alcohol copolymer with a copolymerization ratio of ethylene of 48 mol% or an ethylene-vinyl alcohol copolymer with a copolymerization ratio of ethylene of 38 mol% is preferred.

Examples of the polyketone resin include ketone-ethylene copolymers and ketone-ethylene-propyleneterpolymers, but the polyketone resin is preferably a ketone-ethylene-propylene terpolymer.

The matrix may contain a thermoplastic resin not satisfying Formula 3 or an additive of various types within a range that does not inhibit the effects of the present technology.

For the elastomer constituting the domain, preferably an oxygen permeability coefficient P_{E}(O₂) [cm·cm³/(cm²·s·cmHg)] at a temperature of 21° C. and a relative humidity of 50% and a water vapor permeability coefficient P_{E}(H₂O) [cm·cm³/(cm²·s·cmHg)] at a temperature of 60° C. and a relative humidity of 100% preferably satisfy:
log(P_{E}(H₂O)/P_{E}(O₂)) ≤ 1.5 (Formula 4), more preferably satisfy:
-2.5 ≤ log(P_{E}(H₂O)/P_{E}(O₂)) ≤ 1.0 (Formula 4'), and even more preferably satisfy:
-2.0 ≤ log(P_{E}(H₂O)/P_{E}(O₂)) ≤ 0.5 (Formula 4").

The elastomer with a P_{E}(O₂) and a water vapor permeability coefficient P_{E}(H₂O) satisfying Formula4 readily imparts both low gas permeability and low water vapor permeability to the resin composition prepared by compositing the elastomer with the thermoplastic resin.

The elastomer is not limited as long as the resin composition satisfies Formulas 1 and 2 and the elastomer satisfies Formula 4, but is preferably at least one selected from the group consisting of a butyl rubber, a modified butyl rubber, an olefin thermoplastic elastomer, a styrene thermoplastic elastomer, an ethylene-unsaturated carboxylate copolymer, a polyamide elastomer, and a polyester elastomer.

The butyl rubber (IIR) is an isobutene-isoprene copolymer and can be manufactured by copolymerization of isobutene and a small amount of isoprene using a Friedel-Crafts catalyst at a low temperature at or around -95° C. in a methyl chloride solvent.

The modified butyl rubber refers to a rubber obtained by modifying a butyl rubber, and specific examples include halogenated butyl rubbers and halogenated isobutylene-p-methylstyrene copolymers. Among others, a brominated isobutylene-p-methylstyrenecopolymer is preferred.

Examples of the olefin thermoplastic elastomer include ethylene-α-olefin copolymers, or ethylene-unsaturated carboxylic acid copolymers or their derivatives. Examples of the ethylene-α-olefin copolymer include ethylene-propylene copolymers, ethylene-butene copolymers, ethylene-pentene copolymers, ethylene-hexene copolymers, ethylene-octene copolymers, and their acid-modified products. Examples of the ethylene-unsaturated carboxylic acid copolymer include ethylene-acrylic acid copolymers and ethylene-methacrylic acid copolymers.

Examples of the styrene-based thermoplastic elastomer includes styrenebutadiene-styrene block copolymers (SBSs), styrene-isoprene-styrene block copolymers (SISs), styrene-ethylene/propylene-styrene copolymers (SEPSs), styrene-ethylene/butylene-styrene block copolymers (SEBSs), styrenebutadiene-styrene copolymers (SBSs), styrene-isobutylene-styrene block copolymers (SIBSs), and their maleic anhydride-modified products. Among them, a styrene-isobutylene-styrene block copolymer (SIBS) or a maleic anhydride-modified styrene-ethylene/butylene-styrene block copolymer is preferred.

Examples of the ethylene-unsaturated carboxylate copolymer include ethylene-methyl acrylate copolymers, ethylene-methyl methacrylate copolymers, ethylene-ethyl acrylate copolymers, ethylene-ethyl methacrylate copolymers, ethylene-butyl acrylate copolymers, ethylene-butyl methacrylate copolymers, and their acid-modified products. Among them, a maleic anhydride-modified ethylene-ethyl acrylate copolymer is preferred.

The polyamide elastomer (TPA) is a thermoplastic elastomer having a hard segment of polyamide (e.g., nylon 6, nylon 66, nylon 11, or nylon 12) and a soft segment of polyether (e.g., polyethylene glycol or polypropylene glycol). Polyamide elastomers are commercially available, and a commercially available product can be used in embodiments of the present technology. Examples of the commercially available product of the polyamide elastomer include “UBESTA” (trade name) XPA series, available from Ube Industries, Ltd., and “PEBAX” (trade name), available from ArkemaK.K.

The polyester elastomer (TPEE) is a thermoplastic elastomer having a hard segment of polyester (e.g., poly(butylene terephthalate)) and a soft segment of polyether (e.g., poly(tetramethylene glycol)) or polyester (e.g., aliphatic polyester). Polyester elastomers are commercially available, and a commercially available product can be used in embodiments of the present technology. Examples of the commercially available product of the polyester elastomer include “PELPRENE” (trade name), available from Toyobo Co., Ltd., and “Hytrel” (trade name), available from Du Pont-Toray Co., Ltd.

The domain may contain an elastomer not satisfying Formula 4 or an additive of various types within a range that does not inhibit the effects of the present technology.

The resin composition according to an embodiment of the present technology preferably further contains at least one processing aid selected from the group consisting of a fatty acid, a fatty acid metal salt, a fatty acid ester, and a fatty acid amide. Inclusion of the processing aid can further improve extrudability of the resin composition.

Examples of the fatty acid include stearic acid, palmitic acid, and oleic acid, but stearic acid is preferred.

Examples of the fatty acid metal salt include calcium stearate, magnesium stearate, zinc stearate, and barium stearate. Among them, calcium stearate and magnesium stearate are preferred.

Examples of the fatty acid ester include fatty acid esters obtained by esterification reaction of a higher fatty acid and a lower alcohol, a higher alcohol, or a polyhydric alcohol, the higher fatty acid being obtained by hydrolysis of coconut oil, castor oil, palm oil, beef tallow, or the like.

Examples of the fatty acid amide include stearylamide, palmitylamide, and oleylamide.

The amount of the processing aid is preferably from 0.5 to 5 parts by mass, more preferably from 1 to 4 parts by mass, and even more preferably from 1 to 3.5 parts by mass based on 100 parts by mass of the elastomer in the resin composition. In a case where the content is too high, the barrier properties of the resin composition may deteriorate.

The processing aid may be present in either the matrix or the domain or may be present in both the matrix and the domain.

The resin composition according to an embodiment of the present technology can contain a crosslinking agent. As the cross-linking agent, a crosslinking agent for a typical rubber can be used. Examples include sulfur; divalent metal oxides; diamines; peroxides; and resins for vulcanization, such as modified alkylphenols. Among them, zinc oxide is preferred. The cross-linking agent plays a role of improving processability by crosslinking the elastomer in the resin composition and stabilizing the sea-island structure.

The resin composition according to an embodiment of the present technology can contain an anti-aging agent. Examples of the anti-aging agent include amine anti-aging agents, such as amine-ketone, diallyl amine, and p-phenylenediamine compounds; and phenolic anti-aging agents, such as monophenolic, polyphenolic, and hydroquinone compounds. Among them, N-phenyl-N′-(1,3-dimethylbutyl)-p-phenylenediamine (6PPD), which is a p-phenylenediamine compound, is preferred.

The method for manufacturing the resin composition according to an embodiment of the present technology is not particularly limited, and the resin composition can be manufactured by kneading the thermoplastic resin and the elastomer, and as necessary an additive, such as a processing aid, a crosslinking agent, and an anti-aging agent, with a twin screw extruder or the like.

A second embodiment of the present technology is a refrigerant-transporting hose including a layer of the resin composition of the first embodiment of the present technology.

The refrigerant-transporting hose according to an embodiment of the present technology is preferably used as a hose for transporting a refrigerant of an air conditioner and more preferably used as a hose for transporting a refrigerant of an air conditioner of an automobile.

The refrigerant-transporting hose preferably includes an inner tube, a reinforcing layer, and an outer tube. In the refrigerant-transporting hose according to an embodiment of the present technology, at least one layer of the inner tube is made of the thermoplastic resin composition.

The method for manufacturing a refrigerant-transporting hose is not particularly limited, but the refrigerant-transportinghose can be manufactured as follows: First, the inner tube is extruded into a tube shape by extrusion molding, then a fiber which is to serve as the reinforcing layer is braided on the tube, and further the fiber is covered with the outer tube by extrusion molding of the outer tube on the fiber.

### EXAMPLES

### Raw Materials

The raw materials used in the following examples and comparative examples are as follows.

### Thermoplastic Resin

Ny6: nylon 6, “UBE Nylon” 1022B, available from Ube Industries, Ltd., P_{R}(O₂): 1.0 × 10⁻¹² cm·cm³/(cm²·s·cmHg), P_{R}(H₂O): 65.1 × 10⁻¹² cm·cm³/(cm²·s·cmHg),log(P_{R}(H₂O)/P_{R}(O₂)) = 1.81

Ny6/12: nylon 6/12 copolymer, “UBE Nylon” 7024B, available from Ube Industries, Ltd., P_{R}(O₂): 3.0 × 10⁻¹² cm·cm³/(cm²·s·cmHg), P_{R}(H₂O): 62.0 × 10⁻¹² cm·cm³/(cm²·s·cmHg), log(P_{R}(H₂O)/P_{R}(O₂))= 1.32

Ny11: nylon 11, “RILSAN” (trade name) BESNO TL, available from ArkemaK.K.,P_{R}(O₂): 17.2 × 10⁻¹² cm·cm³/(cm²·s·cmHg),P_{R}(H₂O): 42.6 × 10⁻ ¹² cm·cm³/(cm²·s·cmHg), log(P_{R}(H₂O)/P_{R}(O₂)) = 0.39

Ny 12: nylon 12, “UBESTA” (trade name) 3012U, available from Ube Industries, Ltd., P_{R}(O₂): 20.2 × 10⁻¹² cm·cm³/(cm²·s·cmHg), P_{R}(H₂O): 41.8 × 10⁻¹² cm·cm³/(cm²·s·cmHg), log(P_{R}(H₂O)/P_{R}(O₂)) = 0.32

EVOH-1: ethylene-vinyl alcohol copolymer (ethylene amount 48 mol%), “Soanol” (trade name) H4815B, available from Nippon Synthetic Chemical Industry Co., Ltd., P_{R}(O₂): 0.07 × 10⁻¹² cm·cm³/(cm²·s·cmHg), P_{R}(H₂O): 31.0 × 10⁻¹² cm·cm³/(cm²·s·cmHg), log(P_{R}(H₂O)/P_{R}(O₂)) = 2.64

EVOH-2: ethylene-vinyl alcohol copolymer (ethylene amount 38 mol%), “Soanol” (trade name) E3808, available from Nippon Synthetic Chemical Industry Co., Ltd., P_{R}(O₂): 0.01 × 10⁻¹² cm·cm³/(cm²·s·cmHg), P_{R}(H₂O): 34.9 × 10⁻¹² cm·cm³/(cm²·s·cmHg), log(P_{R}(H₂O)/P_{R}(O₂)) = 3.54

PBT: poly(butylene terephthalate), “NOVADURAN” (trade name) 5010R5, available from Mitsubishi Engineering-Plastics Corporation, P_{R}(O₂): 4.67 × 10⁻¹² cm·cm³/(cm²·s·cmHg), P_{R}(H₂O): 46.1 × 10⁻¹² cm·cm³/(cm²·s·cmHg), log(P_{R}(H₂O)/P_{R}(O₂))=0.99

POK: polyketone, “POKETONE” (trade name) M330A, available from HYOSUNG, P_{R}(O₂):0.7 × 10⁻¹² cm-cm³/(cm²-s-cmHg),P_{R}(H₂O):34.0 × 10⁻¹² cm-cm³/(cm²-s-cmHg), log(PR(H₂O)/PR(O₂))= 1.72 Elastomer

Br-IPMS: brominated isobutylene-p-methylstyrene copolymer, “EXXPRO” (trade name) 3745, available from Exxon Mobil Chemical Corporation, P_{E}(O₂): 87 × 10⁻¹² cm·cm³/(cm²·s·cmHg), P_{E}(H₂O): 18 × 10⁻¹² cm·cm³/(cm²·s·cmHg),log(P_{E}(H₂O)/P_{E}(O₂)) = -0.68

SIBS: styrene-isobutylene-styrene block copolymer, “SIBSTAR” (trade name) 102T, available from Kaneka Corporation, P_{E}(O₂): 91 × 10⁻¹² cm·cm³/(cm²·s·cmHg),P_{E}(H₂O): 17 × 10⁻¹² cm·cm³/(cm²·s·cmHg), log(P_{E}(H₂O)/P_{E}(O₂)) = -0.73

Mah-EP: maleic anhydride-modified ethylene-propylene copolymer, "TAFMER" (trade name) MP0620, available from Mitsui Chemicals, Inc., P_{E}(O₂): 940 × 10⁻¹² cm·cm³/(cm²·s·cmHg), P_{E}(H₂O): 81.3 × 10⁻¹² cm·cm³/(cm²·s·cmHg),log(P_{E}(H₂O)/P_{E}(O₂)) = -1.06

Mah-EB: maleic anhydride-modified ethylene-1-butene copolymer, “TAFMER" (trade name) MH7010, available from Mitsui Chemicals, Inc., P_{E}(O₂): 990 × 10⁻¹² cm·cm³/(cm²·s·cmHg), P_{E}(H₂O): 83.7 × 10⁻¹² cm·cm3/(cm²·s·cmHg),log(P_{E}(H₂O)/P_{E}(O₂)) = -1.07

Mah-EEA: maleic anhydride-modified ethylene-ethyl acrylate copolymer, “HPRAR201”, available from DuPont-Mitsui Polychemicals Co., Ltd., P_{E}(O₂): 910 × 10⁻¹² cm·cm3/(cm²·s·cmHg),P_{E}(H₂O): 87.0 × 10⁻¹² cm·cm³/(cm²·s·cmHg),log(P_{E}(H₂O)/P_{E}(O₂)) = -1.02

Mah-SEBS: maleic anhydride-modified styrene-ethylene/butylene-styrene block copolymer, “Tuftec” (trade name) M1913, available from Asahi Kasei Corporation, P_{E}(O₂): 920 × 10⁻¹² cm·cm³/(cm²·s·cmHg), P_{E}(H₂O): 91.5 × 10⁻¹² cm·cm³/(cm²·s·cmHg), log(P_{E}(H₂O)/P_{E}(O₂))= -1.00

TPA: polyamide elastomer, “UBESTA” (trade name) XPA 9063X 1, available from Ube Industries, Ltd., P_{E}(O₂): 39.3 × 10⁻¹² cm·cm³/(cm²·s·cmHg),P_{E}(H₂O): 70.5 × 10⁻¹² cm·cm³/(cm²·s·cmHg), log(P_{E}(H₂O)/P_{E}(O₂)) = 0.25

TPEE: polyester elastomer, “PELPRENE” (trade name) P40B, available from Toyobo Co., Ltd., P_{E}(O₂): 113 × 10⁻¹² cm·cm³/(cm²·s·cmHg), P_{E}(H₂O): 50.3 × 10⁻¹² cm·cm³/(cm²·s·cmHg), log(P_{E}(H₂O)/P_{E}(O₂)) = -0.34

### Processing Aid

St—Ca— calcium stearate, “SC-PG”, available from Sakai Chemical Industry Co., Ltd.

St—Mg— magnesium stearate, “SM-PG”, available from Sakai Chemical Industry Co., Ltd.

### Cross-Linking Agent

ZnO: zinc oxide, “Zinc Oxide III”, available from Seido Chemical Industry Co., Ltd.

### Anti-Aging Agent

6PPD: N-phenyl-N′-(1,3-dimethylbutyl)-p-phenylenediamine, “SANTOFLEX” (trade name) 6PPD, available from Solutia Inc.

### Comparative Example 1

A rubber composition (a) was prepared with a Banbury mixer in the compounding proportions listed in Table 1, and a tube with a wall thickness of 1.5 mm was extruded with an extruder onto a mandrel coated with a release agent in advance. This was used as an inner layer material. A reinforcing yarn of polyester was braided on the inner layer material using a braiding machine, and a rubber composition (b) prepared with a Banbury mixer in the compounding proportions listed in Table 2 was extruded onto the reinforcing yarn. Then, steam vulcanization was performed at 160° C. for 60 minutes, a mandrel was pulled out, and a hose composed of the inner layer/reinforcing layer/protective layer was manufactured.

The prepared rubber composition and the manufactured rubber hose were measured for the oxygen permeability coefficient and the water vapor permeability coefficient. The results are listed in Table 3.

### Examples 1 to 13 and Comparative Examples 2 to 6

The polymer components were introduced in the compounding proportions listed in Tables 3 and 4 into a twin screw extruder (available from The Japan Steel Works, Ltd.) with a cylinder temperature set at a temperature 20° C. higher than the melting point of the raw material having the highest melting point among the polymer components, and conveyed to a kneading zone with a residence time set for from approximately 3 to 6 minutes and melt-kneaded. The melt-kneaded product was extruded into a strand shape from a die equipped to the outlet. The resulting strand-shaped extrusion product was pelletized using a pelletizer for a resin, and a pellet-shaped resin composition was obtained. The resulting resin composition was measured for the oxygen permeability coefficient and water vapor permeability coefficient. The measurement results are listed in Tables 3 and 4.

From the measurement result of the oxygen permeability coefficient, the thickness expected to give a gas permeation amount equivalent to that of a thickness of 1.5 mm of the rubber composition of Comparative Example 1 was calculated for each example and comparative example, and a tube was extruded with the wall thickness corresponding to the calculated thickness onto a mandrel. This was used as an inner layer material. A reinforcing yarn of polyester was braided on the inner layer material using a braiding machine. A polyester elastomer was extruded onto the reinforcing yarn with an extruder, and a hose composed of the inner layer/reinforcing layer/protective layer was manufactured. The manufactured hose was measured for the inner layer mass (weight reduction effect), bending force (flexibility), and hose moisture permeability. The results were expressed as index values relative to Comparative Example 1, the value for the Comparative Example 1 being assigned to 100, and evaluated as follows.

Inner layer mass: Lower values indicate better effect. Values of 90 or less are determined to indicate weight reduction.

Bending force: Lower values indicate better flexibility. Values of 200 or less indicate handleability causing no problem in use.

Water vapor permeability: Lower values indicate better performance. Values of 700 or less indicate that a resin hose is effective with the weight reduction also taken into account.

The results are listed in Tables 3 and 4.

### Measurement of Oxygen Permeability Coefficient

A sample of the resin composition was formed into a sheet with an average thickness of 0.2 mm using a 40 mm φ single screw extruder (available from Pla Giken Co., Ltd.) equipped with a 550-mmwide T dice, with the temperatures of the cylinder and the dice set at the melting point of the sample plus 10° C. (when the sample was a composition, the melting point is the melting point of the polymer component having the highest melting point in the composition), and at a cooling roll temperature of 50° C. and a take-up speed of 3 m/min. A sample of the thermoplastic resin was formed into a film with a thickness of 0.05 mm by setting the same temperature conditions and adjusting the extrusion amount and the take-up speed in the extrusion. The elastomer and the rubber composition were hot-pressed at a temperature of 180° C. for 10 minutes, and a sheet with a thickness of 0.5 mm was manufactured.

The resulting sheet and film were cut out and measured using an OXTRAN1/50 available from MOCON at a temperature of 21° C. and a relative humidity of 50%.

### Measurement of 10% Modulus

The sheet or film manufactured in the measurement of the oxygen permeability coefficient was punched into a JIS No. 3 dumbbell shape, and a tensile test was performed in accordance with JIS K6301 “Physical Testing Method for Vulcanized Rubber” at a temperature of 25° C. and a speed of 500 mm/min. A stress at 10% elongation (10% modulus) was determined from the resulting stress-strain curve.

### Measurement of Water Vapor Permeability Coefficient

The sheet or film manufactured in the measurement of the oxygen permeability coefficient was cut out and measured using a water vapor permeation tester available from GTR Tech Corporation at a temperature of 60° C. and a relative humidity of 100%.

### Measurement of Hose Moisture Permeability

The hose which has been left in a 50° C. oven for 5 hours was fed with a drying agent (molecular sieves 3A), a volume of which corresponds to 80% of the internal volume of the hose and hermetically sealed. Thehose was left in an atmosphere at 50° C. and a relative humidity of 95%, the weight of the drying agent was measured every 120 hours until 400 hours, and the moisture absorption amount in the equilibrium state was determined.

### Measurement of Bending Force

Two hoses with a length of 45 cm were bent along an arc with a predetermined radius of curvature, and the bending force was measured. The radius of curvature was from 3 times (3D) to 10 times (10D) the outer diameter of the hose. The bending force at a specified radius (4D) was determined from a curve prepared by plotting the relationship between the resulting bending force and the radius of curvature.

The bending force is a measure of flexibility; smaller values of the bending force indicate superior flexibility, and larger values of the bending force indicate poorer flexibility.

Table 1

| Raw materials | Manufacturer brand | Parts by mass |
|---|---|---|
| Brominated butyl rubber | EXXONMOBILE CHEMICAL COMPANY Exxon Bromobutyl 2255 | 100 |
| HAF grade carbon black | Showa Cabot K.K. Show BlackN330 | 50 |
| Paraffin oil | Showa Shell Sekiyu K.K. Machine Oil 22 | 10 |
| Zinc oxide | Seido Chemical Industry Co., Ltd. Zinc Oxide III | 3 |
| Stearic acid | Nippon Oil & Fats Co., Ltd. Beads stearic acid | 1 |
| Sulfur | Hosoi Chemical Industry Co., Ltd. Oil-treated sulfur | 1 |
| Vulcanization accelerator DM | Ouchi Shinko Chemical Industrial Co., Ltd. NOCCELERDM dibenzothiazyl disulfide | 2 |

Table 2

| Raw materials | Manufacturer brand | Parts by mass |
|---|---|---|
| Ethylene/propylene copolymer rubber | Mitsui Chemicals, Inc. Mitsui EPT4070 | 100 |
| FEF grade carbon black | NIPPON STEEL Carbon Co., Ltd. HTC#100 | 80 |
| Paraffin oil | Showa Shell Sekiyu K.K. Machine Oil 22 | 20 |
| Zinc oxide | Seido Chemical Industry Co., Ltd. Zinc Oxide III | 5 |
| Stearic acid | Nippon Oil & Fats Co., Ltd. Beads stearic acid | 1 |
| Sulfur | Hosoi Chemical Industry Co., Ltd. Oil-treated sulfur | 1 |
| Vulcanization accelerator CZ | Ouchi Shinko Chemical Industrial Co., Ltd. NOCCELER CZ-GN-cyclohexyl-2-benzothiazyl sulfenamide | 1 |
| Vulcanization accelerator TT | Ouchi Shinko Chemical Industrial Co., Ltd. NOCCELER TT tetramethylthiuram disulfide | 1 |

Table 3-1

| | | | Comparative Example 1 | Comparative Example 2 | Example 1 |
|---|---|---|---|---|---|
| Thermoplastic resin | Ny6 | Parts by mass | | 60 | 28 |
| | Ny6/12 | Parts by mass | | | 12 |
| | Ny11 | Parts by mass | | | |
| | Ny12 | Parts by mass | | | |
| | EVOH-1 | Parts by mass | | | |
| | EVOH-2 | Parts by mass | | | |
| | PBT | Parts by mass | | | |
| | POK | Parts by mass | | | |
| Elastomer | Br-IPMS | Parts by mass | | 40 | 60 |
| | SIBS | Parts by mass | | | |
| | Mah-EP | Parts by mass | | | |
| | Mah-EB | Parts by mass | | | |
| | Mah-EEA | Parts by mass | | | |
| | Mah-SEBS | Parts by mass | | | |
| | TPA | Parts by mass | | | |
| | TPEE | Parts by mass | | | |
| Processing aid | St-Ca | Parts by mass | | | 2 |
| | St-Mg | Parts by mass | | | |
| Cros slinking agent | ZnO | Parts by mass | | | |
| Anti-aging agent | 6PPD | Parts by mass | | | |
| Oxygen permeability coefficient P(O₂) | | *1) | 63.96 | 7.01 | 10.81 |
| Water vapor permeability coefficient P(H₂O) | | *2) | 16.3 | 68.9 | 28.7 |
| 10% Modulus M10 | | MPa | 2 | 17 | 5.6 |
| P(O₂) x M10 | | | 127.92 | 119.09 | 60.55 |
| log (P(H₂O)/P(O₂)) | | | -0.59 | 0.99 | 0.42 |
| Inner laver thickness | | mm | 1.5 | 0.5 | 0.8 |
| Inner laver mass | | | 100 | 33 | 51 |
| Bending force | | | 100 | 283 | 144 |
| Hose moisture permeability | | | 100 | 1079 | 291 |

* 1) Unit of oxygen permeability coefficient P(O₂): 10⁻¹² cm· cm³/(cm²·s· cmHg)
*2) Unit of water vapor permeability coefficient P(H₂O): 10⁻¹² cm·cm³/(cm²·s·cmHg)

Table 3-2

| | | | Example 2 | Comparative Example 3 | Comparative Example 4 |
|---|---|---|---|---|---|
| Thermoplastic resin | Ny6 | Parts by mass | 20 | | |
| | Ny6/12 | Parts by mass | | | |
| | Ny11 | Parts by mass | | 40 | |
| | Ny12 | Parts by mass | 20 | | 40 |
| | EVOH-1 | Parts by mass | | | |
| | EVOH-2 | Parts by mass | | | |
| | PBT | Parts by mass | | | |
| | POK | Parts by mass | | | |
| Elastomer | Br-IPMS | Parts by mass | 60 | 60 | 60 |
| | SIBS | Parts by mass | | | |
| | Mah-EP | Parts by mass | | | |
| | Mah-EB | Parts by mass | | | |
| | Mah-EEA | Parts by mass | | | |
| | Mah-SEBS | Parts by mass | | | |
| | TPA | Parts by mass | | | |
| | TPEE | Parts by mass | | | |
| Processing aid | St-Ca | Parts by mass | 2 | 2 | 2 |
| | St-Mg | Parts by mass | | | |
| Cros slinking agent | ZnO | Parts by mass | | | |
| Anti-aging agent | 6PPD | Parts by mass | | | |
| Oxygen permeability coefficient P(O₂) | | *1) | 18.27 | 48.73 | 41.12 |
| Water vapor permeability coefficient P(H₂O) | | *2) | 26.3 | 20.9 | 20.1 |
| 10% Modulus M10 | | MPa | 5.4 | 6.3 | 6.5 |
| P(O₂) x M10 | | | 98.68 | 307.02 | 267.27 |
| log (P(H₂O)/P(O₂)) | | | 0.16 | -0.37 | -0.31 |
| Inner laver thickness | | mm | 1.3 | 3.5 | 2.9 |
| Inner laver mass | | | 87 | 232 | 196 |
| Bending force | | | 235 | 730 | 636 |
| Hose moisture permeability | | | 158 | 47 | 54 |

* 1) Unit of oxygen permeability coefficient P(O₂): 10⁻¹² cm· cm³/(cm²·s· cmHg)
*2) Unit of water vapor permeability coefficientP(H₂O): 10⁻¹² cm· cm³/(cm²·s· cmHg)

Table 3-3

| | | | Example 3 | Example 4 | Comparative Example 5 | Example 5 |
|---|---|---|---|---|---|---|
| Thermoplastic resin | Nv6 | Parts by mass | 30 | 30 | | |
| | Nv6/12 | Parts by mass | 10 | 10 | | |
| | Ny11 | Parts by mass | | | | |
| | Ny12 | Parts by mass | | | | |
| | EVOH-1 | Parts by mass | | | 30 | 35 |
| | EVOH-2 | Parts by mass | | | | |
| | PBT | Parts by mass | | | | |
| | POK | Parts by mass | | | | |
| Elastomer | Br-IPMS | Parts by mass | | | | |
| | SIBS | Parts by mass | 60 | 30 | | 65 |
| | Mah-EP | Parts by mass | | | | |
| | Mah-EB | Parts by mass | | | 70 | |
| | Mah-EEA | Parts by mass | | | | |
| | Mah-SEBS | Parts by mass | | 30 | | |
| | TPA | Parts by mass | | | | |
| | TPEE | Parts by mass | | | | |
| Processing aid | St-Ca | Parts by mass | 2 | 2 | | |
| | St-Mg | Parts by mass | | | 2 | 2 |
| Cros slinking agent | ZnO | Parts by mass | | | | |
| Anti-aging agent | 6PPD | Parts by mass | | | | |
| Oxygen permeability coefficient P(O₂) | | *1) | 9.90 | 10.81 | 4.11 | 3.96 |
| Water vapor permeability coefficient P(H₂O) | | *2) | 34.1 | 38.0 | 37.2 | 19.4 |
| 10% Modulus M10 | | MPa | 6.6 | 7 | 6.8 | 6.5 |
| P(O₂) x M10 | | | 65.33 | 75.69 | 27.96 | 25.74 |
| log (P(H₂O)/P(O₂)) | | | 0.54 | 0.55 | 0.96 | 0.69 |
| Inner laver thickness | | mm | 0.7 | 0.8 | 0.3 | 0.3 |
| Inner laver mass | | | 47 | 51 | 20 | 19 |
| Bending force | | | 155 | 180 | 67 | 61 |
| Hose moisture permeability | | | 377 | 385 | 991 | 536 |

* 1) Unit of oxygen permeability coefficient P(O₂): 10⁻¹² cm·cm³/(cm²·s·cmHg)
*2) Unit of water vapor permeability coefficient P(H₂O): 10⁻¹² cm·cm³/(cm²·s·cmHg)

Table 4-1

| | | | Example 6 | Example 7 | Example 8 |
|---|---|---|---|---|---|
| Thermoplastic resin | Ny6 | Parts by mass | | | |
| | Ny6/12 | Parts by mass | | | |
| | Ny11 | Parts by mass | | | |
| | Nv12 | Parts by mass | | | |
| | EVOH-1 | Parts by mass | 35 | | 35 |
| | EVOH-2 | Parts by mass | | 35 | |
| | PBT | Parts by mass | | | |
| | POK | Parts by mass | | | |
| Elastomer | Br-IPMS | Parts by mass | | | 35 |
| | SIBS | Parts by mass | 35 | 55 | |
| | Mah-EP | Parts by mass | | | 30 |
| | Mah-EB | Parts by mass | | | |
| | Mah-EEA | Parts by mass | | | |
| | Mah-SEBS | Parts by mass | | | |
| | TPA | Parts by mass | | | |
| | TPEE | Parts by mass | 30 | 10 | |
| Processing aid | St-Ca | Parts by mass | | | |
| | St-Mg | Parts by mass | 2 | 2 | 2 |
| Crosslinking agent. | ZnO | Parts by mass | | | |
| Oxygen permeability coefficient P(O₂) | | *1) | 5.33 | 5.03 | 5.63 |
| Water vapor permeability coefficient P(H₂O) | | *2) | 24.8 | 24.0 | 24.8 |
| 10% Modulus M10 | | MPa | 5.4 | 6.9 | 5.3 |
| P(O₂) x M10 | | | 28.78 | 34.68 | 29.86 |
| log (P(H₂O)/P(O₂)) | | | 0.67 | 0.68 | 0.64 |
| Inner layer thickness | | mm | 0.4 | 0.4 | 0.4 |
| Inner layer mass | | | 25 | 24 | 27 |
| Bending force | | | 68 | 83 | 71 |
| Hose moisture permeability | | | 511 | 525 | 483 |

* 1) Unit of oxygen permeability coefficient P(O₂): 10⁻¹² cm·cm³/(cm²·s·cmHg)
*2) Unit of water vapor permeability coefficient P(H₂O): 10⁻¹² cm·cm³/(cm²·s·cmHg)

Table 4-2

| | | | Example 9 | Comparative Example 6 | Example 10 |
|---|---|---|---|---|---|
| Thermoplastic resin | Ny6 | Parts by mass | | | |
| | Ny6/12 | Parts by mass | | | |
| | Ny11 | Parts by mass | | | |
| | Ny12 | Parts by mass | | 50 | |
| | EVOH-1 | Parts by mass | 35 | | |
| | EVOH-2 | Parts by mass | | | |
| | PBT | Parts by mass | | | 40 |
| | POK | Parts by mass | | | |
| Elastomer | Br-IPMS | Parts by mass | 35 | 25 | |
| | SIBS | Parts by mass | | | 60 |
| | Mah-EP | Parts by mass | | | |
| | Mah-EB | Parts by mass | | | |
| | Mah-EEA | Parts by mass | 30 | | |
| | Mah-SEBS | Parts by mass | | | |
| | TPA | Parts by mass | | 25 | |
| | TPEE | Parts by mass | | | |
| Processing aid | St-Ca | Parts by mass | | | |
| | St-Mg | Parts by mass | 2 | 2 | 2 |
| Crosslinking agent. | ZnO | Parts by mass | | | |
| Anti-aging agent | 6PPD | Parts by mass | | | |
| Oxygen permeability coefficient P(O₂) | | *1) | 5.18 | 21.78 | 12.79 |
| Water vapor permeability coefficient P(H₂O) | | *2) | 24.8 | 35.6 | 44.9 |
| 10% Modulus M10 | | MPa | 5.7 | 8.1 | 8.2 |
| P(O₂) x M10 | | | 29.51 | 176.40 | 104.90 |
| log (P(H₂O)/P(O₂)) | | | 0.68 | 0.21 | 0.55 |
| Inner laver thickness | | mm | 0.4 | 1.6 | 0.9 |
| Inner laver mass | | | 25 | 104 | 61 |
| Bending force | | | 70 | 420 | 250 |
| Hose moisture permeability | | | 526 | 180 | 386 |

* 1) Unit of oxygen permeability coefficient P(O₂): 10⁻¹² cm· cm³/(cm²·s· cmHg)
*2) Unit of water vapor permeability coefficient P(H₂O): 10⁻¹² cm· cm³/(cm²·s· cmHg)

Table 4-3

| | | | Example 11 | Example 12 | Example 13 |
|---|---|---|---|---|---|
| Thermoplastic resin | Ny6 | Parts by mass | | 20 | 28 |
| | Ny6/12 | Parts by mass | | | 12 |
| | Nv11 | Parts by mass | | | |
| | Nv12 | Parts by mass | | | |
| | EVOH-1 | Parts by mass | | | |
| | EVOH-2 | Parts by mass | | | |
| | PBT | Parts by mass | | | |
| | POK | Parts by mass | 40 | 20 | |
| Elastomer | Br-IPMS | Parts by mass | | 60 | 60 |
| | SIBS | Parts by mass | 60 | | |
| | Mah-EP | Parts by mass | | | |
| | Mah-EB | Parts by mass | | | |
| | Mah-EEA | Parts by mass | | | |
| | Mah-SEBS | Parts by mass | | | |
| | TPA | Parts by mass | | | |
| | TPEE | Parts by mass | | | |
| Processing aid | St-Ca | Parts by mass | 2 | 2 | 2 |
| | St-Mg | Parts by mass | | | |
| Crosslinking agent | ZnO | Parts by mass | | | 3 |
| Anti-aging agent | 6PPD | Parts by mass | | | 1 |
| Oxygen permeability coefficient P(O₂) | | *1) | 9.75 | 9.44 | 10.81 |
| Water vapor permeability coefficient P(H₂O) | | *2) | 17.8 | 21.7 | 28.7 |
| 10% Modulus M10 | | MPa | 8.2 | 7.8 | 5.6 |
| P(O₂) x M10 | | | 79.92 | 73.65 | 60.55 |
| log (P(H₂O)/P(O₂)) | | | 0.26 | 0.36 | 0.42 |
| Inner laver thickness | | mm | 0.7 | 0.7 | 0.8 |
| Inner laver mass | | | 46 | 45 | 51 |
| Bending force | | | 190 | 175 | 144 |
| Hose moisture permeability | | | 201 | 252 | 291 |

* 1) Unit of oxygen permeability coefficient P(O₂): 10⁻¹² cm·cm³/(cm²·s·cmHg)
*2) Unit of water vapor permeability coefficientP(H₂O): 10⁻¹² cm·cm³/(cm²·s·cmHg)

The resin composition according to an embodiment of the present technology can be suitably utilized for manufacturing a refrigerant-transporting hose.

1. A resin composition for a refrigerant-transporting hose, the resin composition comprising:
a thermoplastic resin; and
an elastomer;
the thermoplastic resin and the elastomer forming a sea-island structure of a matrix of the thermoplastic resin and a domain of the elastomer,
the resin composition having a P(O₂), an M10, and a P(H₂O) satisfying Formulas 1 and 2:
0 < P(O₂) x M10 ≤150 (Formula 1), and
log(P(H₂O)/P(O₂)) ≤0.9 (Formula 2),
where the P(O₂) is an oxygen permeability coefficient [cm·cm³/(cm²·s·cmHg)] at a temperature of 21° C. and a relative humidity of 50%, the M10 is a 10% modulus [MPa] at a temperature of 25° C., and the P(H₂O) is a water vapor permeability coefficient [cm·cm³/(cm²·s·cmHg)] at a temperature of 60° C. and a relative humidity of 100%.

2. The resin composition for a refrigerant-transporting hose according to claim 1, wherein the water vapor permeability coefficient P(H₂O) at a temperature of 60° C. and a relative humidity of 100% is 60 x 10⁻¹² cm·cm³/(cm²·s·cmHg) or less.

3. The resin composition for a refrigerant-transporting hose according to claim 1, wherein the oxygen permeability coefficient P(O₂) at a temperature of 21° C. and a relative humidity of 50% is 20 x 10⁻¹² cm·cm³/(cm²·s·cmHg) or less.

4. The resin composition for a refrigerant-transporting hose according to claim 1, wherein the 10% modulus M10 at a temperature of 25° C. is 10 MPa or less.

5. The resin composition for a refrigerant-transporting hose according to claim 1, wherein an oxygen permeability coefficient P_{R}(O₂) [cm·cm³/(cm²·s·cmHg)] of the thermoplastic resin at a temperature of 21° C. and a relative humidity of 50% and a water vapor permeability coefficient P_{R}(H₂O) [cm·cm³/(cm²·s·cmHg)] of the thermoplastic resin at a temperature of 60° C. and a relative humidity of 100% satisfy Formula 3: log(P_{R}(H₂O)/P_{R}(O₂)) ≤5.0 (Formula 3).

6. The resin composition for a refrigerant-transporting hose according to claim 1, wherein the thermoplastic resin is at least one selected from the group consisting of a polyamide resin, a polyester resin, a vinyl alcohol resin, and a polyketone resin.

7. The resin composition for a refrigerant-transporting hose according to claim 1, wherein an oxygen permeability coefficient P_{E}(O₂) [cm·cm³/(cm²·s·cmHg)] of the elastomer at a temperature of 21° C. and a relative humidity of 50% and a water vapor permeability coefficient P_{E}(H₂O) [cm·cm³/(cm²·s·cmHg)] of the elastomer at a temperature of 60° C. and a relative humidity of 100% satisfy Formula 4: log(P_{E}(H₂O)/P_{E}(O₂)) ≤1.5 (Formula 4).

8. The resin composition for a refrigerant-transporting hose according to claim 1, wherein the elastomer is at least one selected from the group consisting of a butyl rubber, a modified butyl rubber, an olefin thermoplastic elastomer, a styrene thermoplastic elastomer, a polyamide elastomer, and a polyester elastomer.

9. The resin composition for a refrigerant-transporting hose according to claim 1, further comprising at least one processing aid selected from the group consisting of a fatty acid, a fatty acid metal salt, a fatty acid ester, and a fatty acid amide.

10. A refrigerant-transporting hose comprising a layer of the resin composition according to claim 1.
